(19) United States
(12) Patent Application Publication
(10) Pub. No.: US 2002/0049971 A1
(43) Pub. Date: Apr. 25, 2002

(54) System and method for transmitting program guide and other information in a television distribution system

(76) Inventors: Joseph E. Augenbraun, Princeton, NJ (US); Bruce Plotnick, Jamison, PA (US); Errol J. D'Souza, Sicklerville, NJ (US); Jonathan P. Wurtz, Bryn Mawr, PA (US); Ori Pessach, Philadelphia, PA (US); Aaron Grosky, Doylestown, PA (US)

Correspondence Address: William A. Blake, Jones, Tullar & Cooper, P.C., P.O. Box 2266, Eads Station, Arlington, VA, 22202, US

(21) Appl. No.: 09/770,678

(22) Filed: Jan. 29, 2001

Related U.S. Application Data
(60) Provisional application No. 60/177,710, filed on Jan. 27, 2000.
(60) Provisional application No. 60/202,662, filed on May 8, 2000.

(51) Int. Cl. H04N 5/445

(52) U.S. Cl. 725/39; 725/44

(57) ABSTRACT

A system and method for transmitting programming guide and other information in a television distribution system permits selective access to the information. The information is formatted at a server (20) located in a network headend (12) into pages of text information, such as program listings for groups of channels at selected times of day, and preferably is broadcast continually on one or more designated channels (18) to a plurality of viewer set tops (16). Each of the set tops (16) contains a terminal processor (29) which facilitates selection and display of the downloaded information by means of a script program or application. The server (20) preferably feeds the formatted pages of text in a repeating carousel manner to a multiplexer (27) that transmits the pages on one or more digital channels to the set tops (16). Preferably, a background screen on which the program listing information is to be overlayed is separately transmitted or is stored in the set tops (16). Preferably, the pages of program listing information are organized by the server (20) in multiple ways, such as by channel or category.

### PRIORITY CLAIM UNDER 35 U.S.C. 119(e)

This application claims the benefit under 35 U.S.C. 119(e), of U.S. Provisional Application No. 60/177,710, filed Jan. 27, 2000 and U.S. Provisional Application No. 60/202,662, filed May 8, 2000.

### BACKGROUND OF THE INVENTION

1. Field of the Invention

The present invention relates generally to a system and method for transmitting and displaying information in a television distribution system. While not limited thereto, the present invention is particularly suited for transmitting television program guide information from a central location in a television distribution system so that the guide information can be accessed and displayed on an end user's television.

2. Description of the Background Art

With the increase in the number of television programs available to viewers through broadcast television, cable television systems and satellite television systems, viewers may be presented with hundreds of television programs from which to choose. Although providing such a large number of programs is obviously advantageous from a viewer satisfaction standpoint, it is imperative that the viewer be provided a convenient means by which they can readily choose a particular program to view. To address this issue, cable and satellite television system providers may provide an on-screen program guide that the viewer can access to determine what programs are available for viewing at any given time. In its simplest form, the program guide is broadcast on one or more of the cable or satellite channels, and displays the current programming listings in a scrolling fashion. This type of program guide is easy to implement, but is disadvantageous because it typically displays program listings only for the current time, and for perhaps the next hour. Further, the viewer must wait for the guide to scroll to their channels of interest, which can take some time, especially where listings for a hundred or more channels are being displayed.

To overcome the shortcomings of conventional broadcast program guides, program guides have been developed in which extensive program listing information is periodically downloaded to a viewer's set top converter box (set top) for selective retrieval by the viewer. Typically, these types of guides enable a viewer to access programming information for an entire viewing day, for example, and the viewer can select the time and channel or channels of interest so that they need not scroll unnecessarily through other listings that are not of interest to them. However, these type of set top based program guides still nevertheless suffer from a number of drawbacks. First, they require a large amount of fixed storage space in the set top to enable storage of the downloaded program listing information. Second, they require that a dedicated application be provided in the set top to access and display the program information. This makes the system inflexible since any changes to the way the guide operates, e.g., look and feel, cannot be made without changing the application in every viewer's set top. Further, the set top-based application is limited to the on-screen display capability of the set top. As a result, the display tends to be static and unattractive.

### SUMMARY OF THE INVENTION

The present invention overcomes the foregoing drawbacks of set top-based programming guides through provision of a system and method for transmitting programming guide and other information that is server-based, but nevertheless still permits viewers to access programming and other information selectively. More particularly, the information is formatted at a local server located in a network headend, and preferably is broadcast continually on one or more designated channels to a plurality of viewer set tops. Each of the set tops contains a terminal processor which facilitates selection and display of the downloaded information by means of a script program or application. In contrast to a set top-based programming guide, the present invention does not require storage of all of the program listing data in the set top since this data is continually broadcast.

Preferably, the programming guide data or other information is stored in a remote server, and is accessed by the headend, either through the Internet, or through another suitable communications link. Alternatively, the data is stored in a database in the headend. The local server in the headend formats the data into script pages, preferably HTML or HTML-like pages. This arrangement is advantageous because the formatting can be readily changed without any re-programming of the set tops. Thus, for example, the look and feel of the program guide can be readily changed at the headend since it is not stored in the individual set tops.

In the preferred embodiment, the local server preferably feeds the formatted script pages in a repeating carousel manner to a multiplexer that transmits the pages on one or more channels to the set tops. To minimize bandwidth requirements, the script pages are preferably digitally encoded, e.g., using MPEG encoding, and are each assigned by the multiplexer to a packet identifier (PID) in one or more digital channels. For example, in the use of the invention for transmitting a programming guide, each page of program listing information is preferably assigned to a PID, or a time slot within a PID. A dedicated channel may be employed to broadcast all of the script pages of the programming guide in this manner. Ancillary data, such as program description, can also be contained within each page of text information. Thus, when a viewer wants to access the detailed description of one of the programs listed on a particular page, this information can be quickly accessed since it is contained in the same page.

Another feature that is preferably employed and reduces bandwidth requirements is the use of a dedicated channel or PID for transmitting a background screen on which the program listing information is to be overlayed. More particularly, the same background screen may be employed for all or several of the script pages, and the data scripts of programming information for each page are displayed within the parameters of the background screen. By transmitting a background screen which can be utilized with multiple script pages, substantial bandwidth is saved because only the data information for each script page needs to be transmitted through the distribution network. Preferably, the background screen is transmitted as digitally encoded video that facilitates provision of attractive, dynamic background art for the background screen. Alternatively, the background screen can be a bit map or other still image file that is downloaded to and stored in the set tops.

The script program or application in the set top manages the navigation by the viewer from one page or screen of information to another in response to viewer entered commands. For example, if a viewer presses a button on their remote control that requests access of a particular page of program listings, the script program will identify a PID where the requested information is located, and retrieve the information from the broadcast stream for display on the viewer's television or monitor. To reduce delays in retrieving the information, related script pages, e.g., all pages for channel listings for a given time period, may be pre-cached in a memory contained in the set top. However, it should nevertheless be noted that the programming guide application requires very little memory, so that the majority of the set top memory is available for other applications.

In the preferred embodiment, a viewer navigates the program guide in the following manner. When initially selected, the guide will preferably start with the programming information for the first group of channels for a given time period. The viewer can then highlight each of the channels by pressing the appropriate buttons (e.g., up/down arrows) on their remote control. As each channel and program is highlighted, a description of the program for the selected channel is displayed in a dedicated box on the background screen. As the viewer scrolls down the channel list, the user will eventually reach the bottom of the page. Pressing the down button at this point will cause the script program to access the script page for the next group of channels. Similarly, left/right arrow keys, for example, may be employed to access script pages for different times of day. Another preferred feature of the invention is the provision of forced tuning in which a viewer can tune directly to a program from the program guide. This can be accomplished, for example, by the viewer holding down the select or enter button while the desired channel is highlighted.

Preferably, the script pages of program listing information may be organized by the local server in multiple ways. The most common way is by channel, although the listings can also be based by category, e.g., movies, sports, children's, music and PPV. With this arrangement, each group of script pages will be assigned to a PID so that viewers can view the listings using any of the categories. As an additional option, each viewer may have their own list of favorite channels for formatting of viewer specific script pages.

### BRIEF DESCRIPTION OF THE DRAWINGS

The features and advantages of the present invention will become apparent from the following detailed description of a number of preferred embodiments thereof, taken in conjunction with the following drawings in which:

FIG. 1 is a block diagram of a television distribution system that is configured to implement the preferred embodiments of the present invention;

FIG. 2 is an illustration of a sample background screen that may be employed with the preferred embodiments; and

FIGS. 3-8 are illustrations of example video display screens that are generated for use with an on-screen programming guide that is preferably implemented with the preferred embodiments of the present invention, with FIG. 3 showing the first page of a guide for all channels;

FIG. 4 showing a highlighted entry on the first page of the “all channels” guide;

FIG. 5 showing the last page of the “all channels” guide;

FIG. 6 showing the first page of the “all channels” guide for a half hour ahead of time;

FIG. 7 showing a page from the “movies category” guide; and,

FIG. 8 showing a page from the “sports category” guide.

### DETAILED DESCRIPTION OF THE PREFERRED EMBODIMENTS

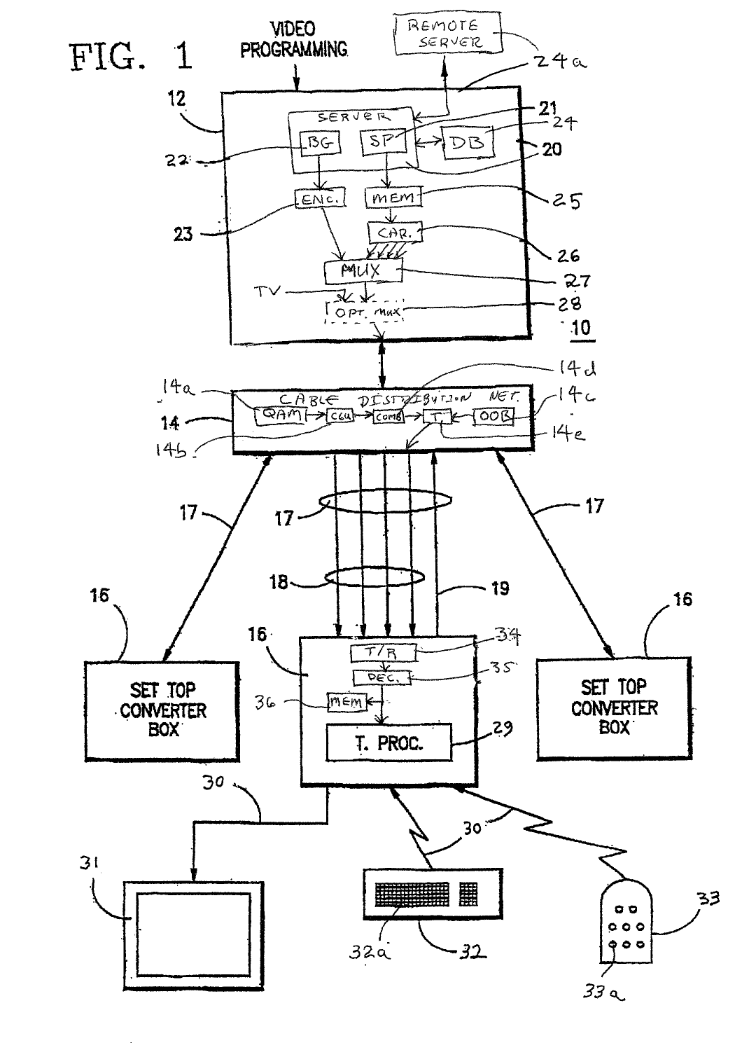

FIG. 1 is a general block diagram of a television distribution system 10 which incorporates elements for facilitating the generation and transmission of script pages, background screens and other information to a plurality of system users, and is illustrative of one type of system with which the concepts of the present invention may be employed. The television distribution system is illustrated as being a CATV system, although it will be understood that it can also be any other type of television distribution system, such as a satellite based system, for example. It should also be noted that the system 10 is illustrated in general form since many of its detailed elements are not necessary for an understanding of the present invention.

The television distribution system 10 includes a network or cable headend 12 and an RF cable television distribution network 14 for interfacing the headend 12 to a plurality of set top converter boxes or terminal devices 16. The television distribution network 14 includes a QAM modulator 14a, a C6U RF modulator 14b, an on out-of-band modulator 14c, a RF combiner 14d and a transmitter 14e. A plurality of transmission links 17 interconnects the set top converter boxes (set tops) 16 with the distribution network 14. Each of the links 17 is illustrated as being bidirectional with a plurality of downstream channels 18 and one or more upstream channels 19. However, it should be understood that the upstream channel 19 is not necessary for some embodiments of the present invention as will be discussed in greater detail later.

The cable headend 12 receives video programming from remote sources (not shown), and transmits the video programming and other information through the distribution network 14 to the set tops 16. Typically, the video programming is received from the remote source in either an analog format, or a digitally compressed or encoded format, such as MPEG 1 or MPEG 2.

A local server 20 is located in the headend 12 which performs the necessary formatting of program guide or other information to facilitate transmission of the same to the set tops 16. The server 20 contains a script generator 21 for generating various scripts of data known as script pages. Preferably, the script pages are generated in HTML or HTML-like format. It will be understood, however, that any scripting language such as JAVA, XML or CGI, may be utilized. The information contained in the script pages 21 can be of any type, such as program listing information, directory information identifying relationships between related script pages, Internet-based information, instructional information, etc.

The server 20 also preferably includes a background screen generator 22 for generating a background screen to be transmitted separately from the script pages. The background screen is preferably formed as a video stream to allow motion in the screen. However, it will be understood that the background screen could be a still picture as well, in which case it can be formatted in any suitable image format, such as a bit map, for example. The video stream is preferably passed to a digital encoder 23, which may be an MPEG 1 or MPEG 2 encoder, for example, which encodes the background screen before transmission through the distribution network 14 to the set tops 16. The encoder 23 is employed to reduce the bandwidth necessary to transmit the background screen.

The program listing or other information provided to the script generator 21 may be obtained locally from a database 24, or from remote sources, such as through the Internet, or other communications media. In the preferred embodiment where the data concerns programming information, such data may be obtained from the local operators, from the programming sources, from third parties that provide programming information, or any combination thereof. It is preferred, however, that the programming data be obtained from a remote, central server 24a that gathers all of the information from the various sources, and creates program listings for one or multiple headends.

The script generator 21 utilizes the received information to create the appropriate scripts, including providing tags known as packet identifiers (PIDs), which identify each script page and formats the script page such that it will properly overlay the background screen. In addition to generating script pages, the script generator 21 also creates databases and one or more data directories which track the relationship between the various script pages, as well as the means of transmission for each script page. This provides for quick retrieval of the proper script page when requested. When a viewer requests programming information, the data directories are utilized to properly configure the script pages and to determine the identification of and location of related script pages that can be accessed from a current page through activation of various function keys (e.g., PAGE UP, PAGE DOWN, SELECT, ENTER, and left, right, up and down arrows) on a keyboard or remote controller as will be discussed in greater detail later. In effect, each PID acts as a virtual channel that can be accessed by the set tops 16 as will be discussed in greater detail later. The script generator 21 thus creates a channel mapping directory that correlates each of the script pages with one of the virtual channels. In this manner, when a page is retrieved from the broadcast datastream, that page also contains all of the information pertaining to all other pages related to or referenced by that page so that these other pages can be pre-cached to facilitate rapid access. As an example, if a viewer scrolls down to the last selection on a page, and presses the down arrow key on their remote controller, this feature enables the next page of programming information to be quickly retrieved and displayed.

Preferably, the generated script pages are passed to a memory 25 where the script pages are stored so that they can be accessed and broadcast on a continual basis to the set tops 16. To facilitate broadcast of the stored script pages, one or more carousel applications 26 are provided which access the pages and feed them to a multiplexer 27. The multiplexer 27 multiplexes the script pages and MPEG video background screen into a sequential packetized datastream in which the data for each page is repeated in a carousel manner. The multiplexed datastream is thereby transmitted through the distribution network 14 in the PIDs of one or more digital broadcast channels. In an alternative embodiment, a second, optional multiplexer 28 is also provided which enables multiplexing of additional sources of information, e.g., digital television sources, Internet, etc., with the programming guide script pages and background screens. This arrangement makes more efficient use of the digital channel on which the programming guide script page and background screen PIDs are broadcast. In an alternative embodiment, one or more of the script pages may be downloaded to the set tops 16 in response to requests received therefrom on the upstream channels 19 so that the script pages need not be continually broadcast. However, broadcasting is preferred to minimize page request response time.

It should be understood that the foregoing script page generator architecture represents but one manner in which the present invention could be implemented, and the present invention is not limited to such an implementation. For example, as one possible alternative to the foregoing arrangement, the local server 20 can be Web based, so that the script pages containing the programming information can be accessible at a Web site on the Internet. In this arrangement, the cable headend 12 would have access to the Internet, and the script pages would preferably be accessed therefrom, and downloaded through the distribution network 14 to the set top boxes 16, on a channel dedicated to Internet based information, for example. Thus, if a viewer is “surfing” the Internet, they can easily access the site for the programming guide.

Each of the set top boxes 16 is interfaced via a terminal processor 29 and associated communication links 30 (e.g., cables, infrared wireless links, etc.) to a television or monitor 31, and one or more input devices, such as a wireless keyboard 32 and a remote controller 33. Each of the input devices includes a plurality of selection keys 32a and 33a, respectively, for sending commands to the set top 16 and/or cable headend 12. A receiver 34 and a transmitter 34a are provided in the set top 16 to facilitate communication with the headend 12.

As each set top box 16 receives the digitally encoded or compressed background screen data from the distribution network 14, it is passed through a decoder 35 which restores the background screen to its original form for display on the television or monitor 31. The decoder 35 is of the same format as the encoder 23, such as MPEG 1 or MPEG 2, for example. The set top 16 also includes a memory 36 for storage of the script pages and directory or channel mapping information, as well as the background screen in the event that the background screen is not a broadcast video stream. The memory 36 may be employed to pre-cache script pages in advance of them being requested to improve response time as discussed elsewhere. The terminal processor 29 runs a script application that responds to the inputs of the viewer by accessing the appropriate PIDs and pages therein from the broadcast stream. The script application and other pertinent information is preferably downloaded from the headend 12 by the out-of-band modulator 14c through one of the downstream channels 18 that is employed for out-of-band signaling. It should also be noted that the channel mapping or directory information can also be downloaded using the out-of-band modulator 14c in an alternative embodiment of the invention.

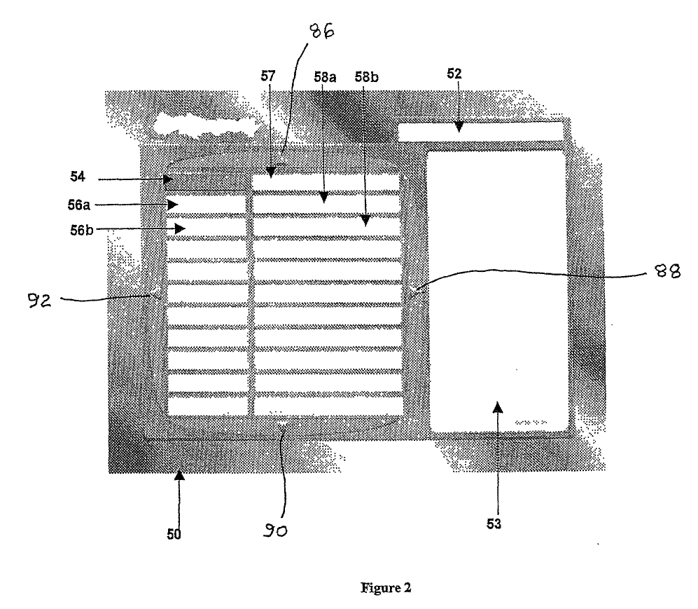

Referring to FIG. 2, a sample background screen 50 for display on a television monitor is illustrated. As discussed previously, the background screen 50 is preferably an MPEG 1 or MPEG 2 video stream that is broadcast on a designated PID of a digital channel, and may contain various features, such as animation. The background screen 50 illustrated in FIG. 2 contains various areas 52, 53, 54, 56a, 56b, 57, 58a, and 58b for example, where script data may overlay the background screen 50.

In the preferred embodiment of the present invention, the script pages transmitted through the distribution network 14 contain television programming information. As previously discussed, the television programming information provided to the script generator 21 may be provided locally, remotely or through a third party source. This programming information typically contains channel information and television programming information. The channel information preferably contains each channel's call letters, each channel's assigned number within the particular television distribution system, network affiliation, and a characterization of the channel (e.g., Sports, News, Weather, Movies etc. . . . ). The television programming information preferably contains information regarding the titles of the various programs shown on each of the available channels, the start time and run time of each program, a description of each program, ratings of the programs, advisories pertaining to the programs (e.g., Adult Language, Nudity . . . ), and whether closed captioning and the like for the program is available. It will be understood that other programming characteristics may also be provided with respect to the television programming information.

Upon receiving the television programming information, the script generator 21 processes the information to generate various script pages. In the preferred embodiment, the script generator 21 processes the programming information to generate script pages of programming information for various time intervals of each day. Preferably, the script generator 21 generates updated script pages on a periodic basis, e.g., every half hour, to save bandwidth such that the script pages cover a sliding time window to continuously provide a set amount of look-ahead time, e.g., 8 hours. Preferably, the script pages are formatted to properly overly the background screen.

The script pages may be formatted such that each script page will contain programming information only for a fixed period of time (e.g., one-half hour, or one hour). It will be understood that the script pages may be generated for any period of time, and that the present invention is not limited to displaying programming information for any particular time interval. Preferably, each script page will contain programming information for only a fixed number of television channels (e.g. 10 channels) so all of the channels and programming information contained in one script page will be displayed within the viewing area of the television monitor 31. Because television distribution systems may provide hundreds of channels for its subscribers, the script generator 21 will generate groups of script pages containing programming information for the various channels in the same time interval. For example, if the television distribution system 10 offers 150 channels, the script generator 21 may generate 15 script pages of programming information, where each script page contains programming information for 10 channels.

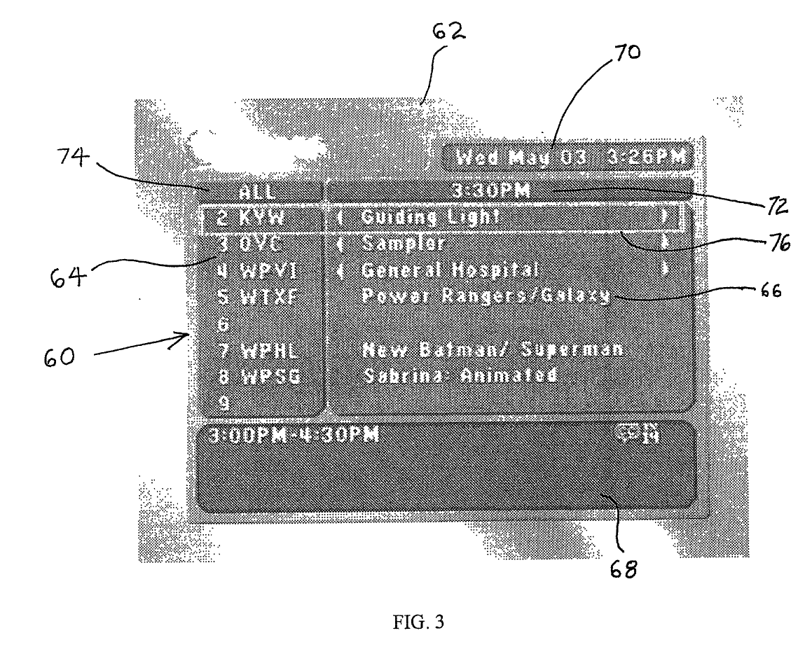

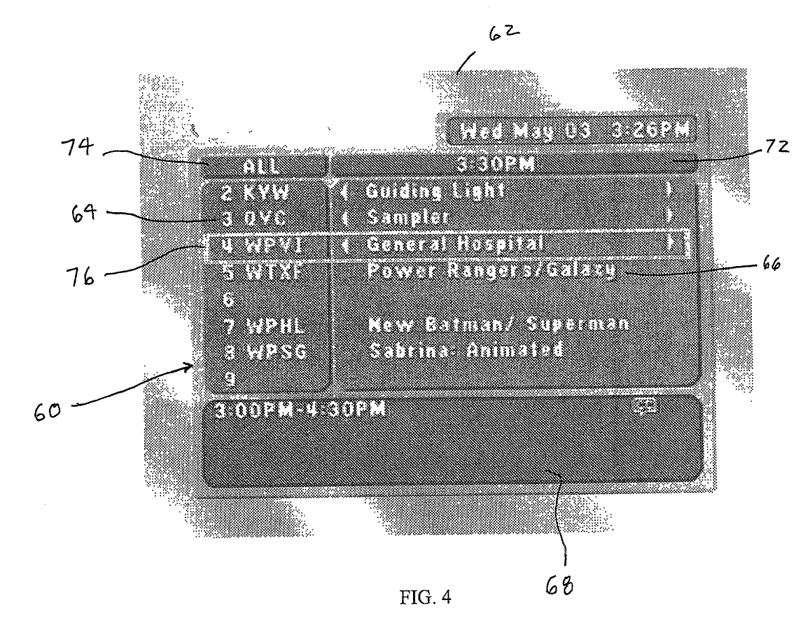

FIGS. 3-8 are illustrations showing various examples of the types of script pages that may be displayed in the preferred embodiment. In FIG. 3, a script data page 60 containing television programming information is illustrated overlaying a background screen 62. The script data page 60 preferably contains channel information 64, program titles 66, program descriptions and related information 68 (alternatively can be used for other information, such as advertising), current date and time 70, time interval of the programming information 72, and category of television programming 74. The script pages are formatted by the script generator 21 so the programming information overlays the various empty spaces of the background screen 62.

Preferably, the channel information 64 in the present invention will be listed by channel number and station call letters, but may be listed by some other channel characteristics as well. For the time interval 72 of each script, television program titles will be displayed in some logical relationship to each program's corresponding station for that time interval. As illustrated, the program titles 66 are displayed directly to the right of the associated channel information 64.

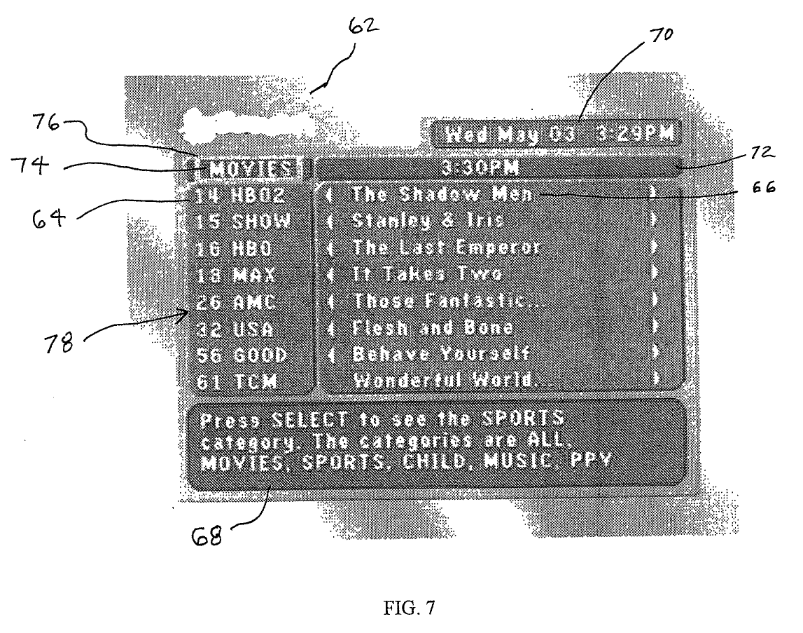

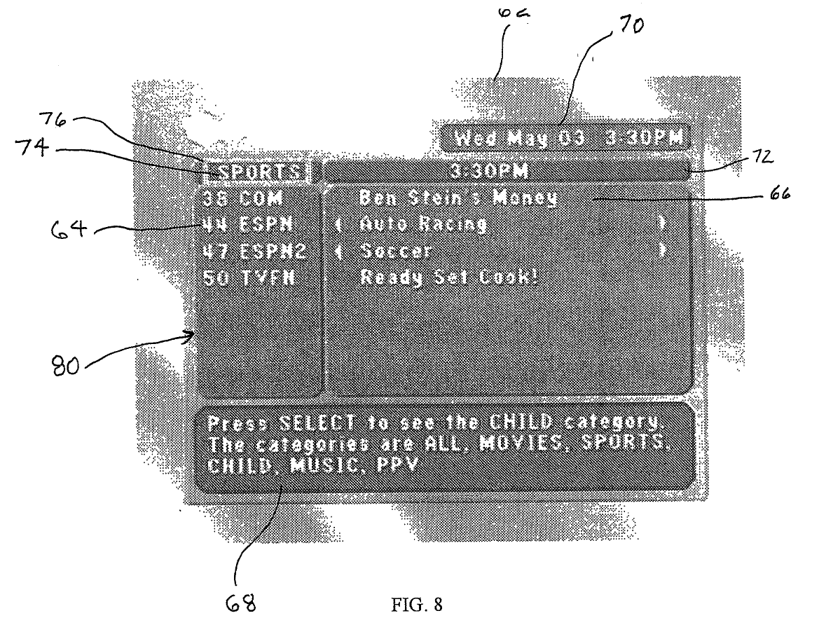

The script page generator 21 is not limited to generating script pages based only on channel number and time. The script page generator 21 may also generate script pages for other programming characteristics such that multiple groups of script pages are generated. For example, script pages may be generated by channel characteristics, such as creating script pages for sports channels, movie channels and news channels. In addition, the script page generator may also generate script pages which contain a listing of all programs with certain characteristics that may be displayed at a given time. For example, one or more script pages may be generated which contain a listing of all movies, sports programs or music programs being shown at a given time. Examples of movie and sports category script pages 78 and 80 are shown in FIGS. 7 and 8, respectively. Preferably, the categories include “ALL” (program listings of all available channels), “MOVIES” (program listings of all movies), “SPORTS” (program listings of all sports programs), “CHILDREN” (program listings of all children's programs) “MUSIC” (program listings of all music related programs), and “PPV” (program listings of all pay-per-view programs). It will be understood that the present invention is not limited to the categories of programs listed above, and that other categories of programs may be utilized.

A viewer may review program listings for a particular category of programming information by navigating to and highlighting the category box 74 and pressing the designated select key, as described above. By pressing the designated select key, the category and associated programming and channel information is changed. This is accomplished by obtaining the first script page for the new category for that time interval. By continuing to press the designated select key, the user may scroll through the various categories and related programming and channel information associated with the category displayed in the category box 74.

As yet another alternative, the script pages can be individualized for each set top 16, or for each viewer for a given set top 16. For example, each person in a household may have a list of favorite channels for which they wish to receive script pages containing programming information dedicated to only those channels. The set top box 16, the headend 12 or a combination of the two can contain the necessary programming to allow the individual viewers to program their own list of favorite channels so that each viewer has the option to receive programming information for only those channels if they desire.

Another method of implementing favorite channels is to store in non-volatile memory in the set top 16 user preference variables that are meaningful only to the scripts. If the scripting language allows scripts to set these variables and to affect the display images shown according to these variables, scripts could be implemented that allow the user to set up favorite channels and to display program listings for those favorite channels. The advantage of this approach relative to the typical approach of hard-coded favorite channel management within the set top 16 is the flexibility of user interface—the favorite channels user interface could be customized by the cable operator, different for kids or for senior citizens, etc.

To access programming information, a viewer presses a designated one of the key 32a or 33a on the input device 32 or 33. Preferably, the designated key to activate the programming information will bear some logical relationship to the desired task, such as pressing a “G” key or a “Guide” key on the input device 32 or 33. It will be understood that any key or combination of keys may be used to activate the programming information. Activation of the key or keys preferably causes the set top 16 to be tuned to a designated channel on which the background MPEG screen and script pages are broadcast.

Upon activation of the program guide, an initial “default” script page will be retrieved by the set top 16 and displayed. This page can of course be any desired page, such as a “best bets” page that lists recommended programming for the present or upcoming time interval, or the first page of channel lisitings for the current time interval, such as the script page 60 in FIG. 3. When the user exits and then re-enters the program guide, this default page will once again be initially displayed. Alternatively, the last script page that was viewed during the previous program guide session can be stored in the memory 36, and accessed upon return to the program guide by the viewer.

As discussed previously, it is also preferable that related script pages be pre-cached in the memory 36 of the set top 16 to allow the viewer to retrieve and display programming information quickly. Examples of related script pages that may be cached may include script pages containing programming information for the prior or next time interval, or for a prior or next group of channels. The script pages may be pre-cached prior to the viewer even actuating the guide key, and may be periodically updated.

Referring again to FIG. 3, assume that upon activation of the program guide, the script page 60 for a given time period, e.g., the current or next half hour, will be retrieved and displayed as an overlay on the background screen 62 such that the script data will be displayed over the various areas of the background screen 62. In the example shown in FIG. 3, the current time is 3:26 p.m., and the script page 60 contains programming information for the first series of channels during the next time interval (3:30 p.m.) 72 since the current time interval is almost over, and a viewer is unlikely to desire programming information for the current time interval. It is therefore preferable that information for the next time interval be displayed once a preset amount of time in the current interval has passed. For example, this could occur after 22 minutes have passed in a 30 minute time interval. Once the program guide is activated, the script pages containing programming information for the next series of channels in the current (or next) time interval are preferably cached in the memory 36 of the set top 16, as well as the script pages containing programming information for the next succeeding time interval (4:00) or several time intervals are also cached in the memory 36.

When a viewer navigates through the displayed information, a single rectangular box 76 preferably highlights both the channel information and the program title so that the viewer may select the program for further information or viewing. The method of highlighting the channel information and program title may take many forms, including, but not limited to, drawing a dark or light border around the information, placing an image overlaying the information, shading the information or changing the color of the information. It also will be understood by those skilled in the art that highlighting information is not limited to a visual display, but highlighting may also include playing of audio signals or messages, or a combination of visual and audio signals or messages.

A user may navigate through a displayed script page by pressing a designated key or keys on the input device 32 or 33. Preferably, the specific key or keys bear some logical relationship to the desired task, such as the right arrow key when pressed navigates to the information located to the right of the currently highlighted information; the left arrow key when pressed will navigate to the information located to the left of the currently highlighted information; the up arrow key will navigate to the information above the currently highlighted information; and the down arrow key will navigate to the information below the currently highlighted information. It will be understood by those of ordinary skill in the art that any key or combination of keys may be used to navigate in a certain manner.

When one of the directional keys is pressed, the highlighted rectangle 76 will highlight the information in the direction of the pressed directional key. Thus, by pressing the down arrow key on the input device 32 or 33, the highlight 76 will move down to the next line of programming information. In the event that program description information is contained in the area 68, the information contained in the program description area 68 will change as the user navigates from one program and channel information listing to another, so that the displayed information 68 pertains to the highlighted program.

The present invention also permits a viewer to tune to the channel that is contained in the currently highlighted area 76. More particularly, when a viewer presses a select or enter key on the input device 32 or 33 when a program and channel information is highlighted, the tuner in the set top 16 will tune to the selected channel on which the highlighted program is broadcast. Preferably, the tuner will tune to the selected channel even though the user may be viewing programming information for a future time interval.

A user may also tune to a channel by pressing the CHANNEL UP or CHANNEL DOWN key on the input device 32 or 33, which will deactivate the programming information and tune to the channel one channel up or one channel down, as the case may be, from the channel tuned to when the programming information was activated.

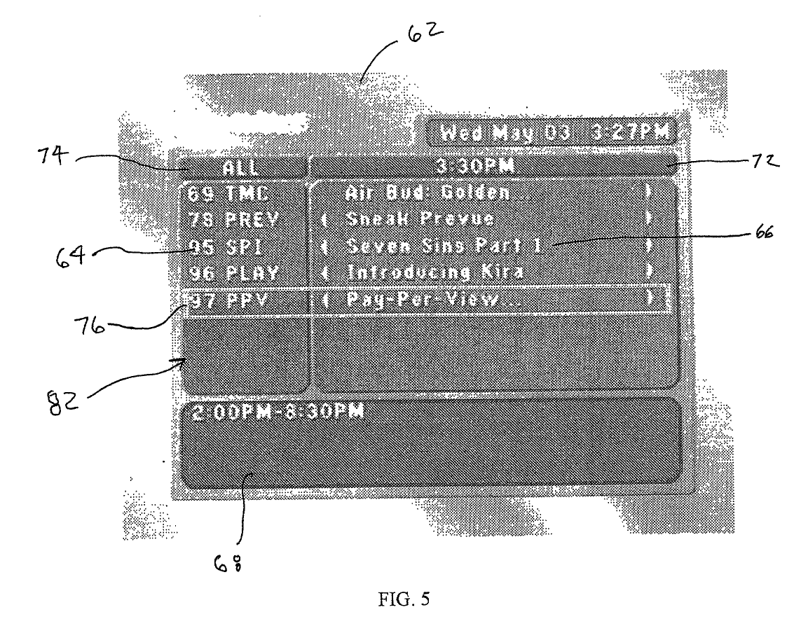

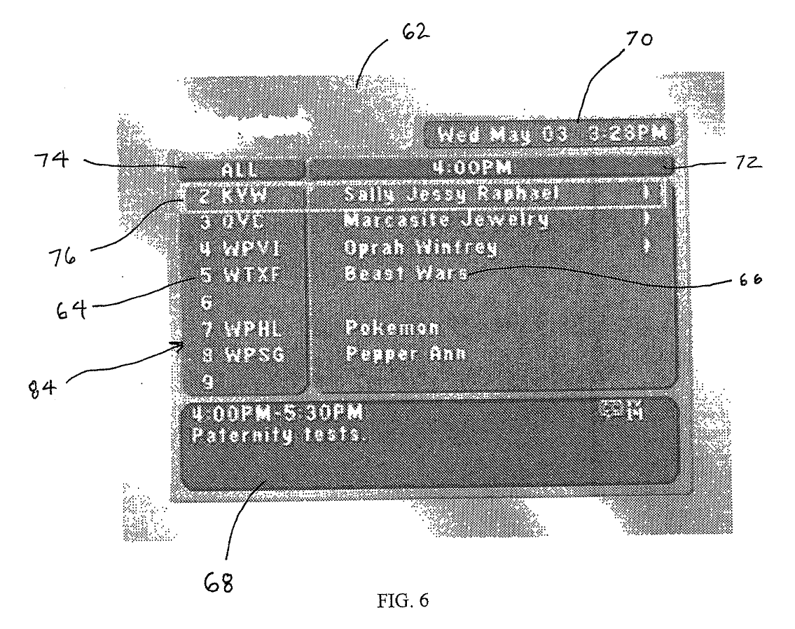

FIG. 5 shows a script page 82 in the example covering the highest channel numbers. In this example, the highlighter is on the highest channel, channel 97. If the viewer actuated the down arrow key on their remote control, the script page 60 for the first group of channels will be recalled as illustrated in FIG. 3, and the first channel, channel 2, will be highlighted. Similarly, if the viewer next presses the right arrow key, a script page 84 for the next time period, in this example 4:00 PM, will be displayed as illustrated in FIG. 6.

Although in the most preferred embodiment, the viewer actuates the arrow keys on the input device 32 or 33 to navigate to other script pages, FIG. 2 shows an alternative embodiment in which the script page contains a group of four arrows 86, 88, 90 and 92 which the user may navigate to by pressing the appropriate key on the input device 32 or 33, in a similar manner as previously discussed. When the viewer navigates to one of the arrows 86-92 displayed on the screen and the arrow is highlighted, the viewer may obtain program listing information associated with that particular arrow by pressing the designated “Select” or “Enter” key on the input device 32 or 33. For example, if a viewer has navigated to and highlighted the right arrow 88 on the displayed screen, pressing the designated select key will display the script page containing programming information for the next time interval. Similarly, the viewer may obtain programming information on the next series of channels within the same time interval by highlighting the down arrow 90 and pressing the designated select key. Navigating between script pages in the present invention can also be accomplished in still further ways. For example, a viewer may also view a script page containing the previous or subsequent group of channels by pressing the PAGE UP or PAGE DOWN key, respectively, on the input device 32 or 33.

It will be understood that the scope of the invention is not limited to the embodiments described above, and that the above and numerous additional variations and modifications could me made thereto without departing from the scope of the invention as set forth in the following claims.

1. A system for transmitting program guide information in a television distribution system comprising:
a) a network headend, said headend including
1) a script generator for generating a plurality of pages of programming information from said program guide information, at least some of which include programming description information for a group of television channels during a selected time interval; and
2) a multiplexer for generating a multiplexed datastream in which said pages are interleaved with one another, and repeated in a carouseled manner;
b) a distribution network for broadcasting said multiplexed datastream; and
c) at least one downstream channel interfaced to said distribution network for broadcasting said pages of programming information to one or more terminal devices.

2. The system of claim 1, further including a plurality of terminal devices interfaced to said at least one downstream channel for receiving said pages of programming information, each said terminal device including:
1) a receiver for receiving said pages of programming information; and
2) a terminal processor for managing display of said pages of programming information, said terminal processor including a terminal processor application for selectively accessing one or more of said pages in response to inputs from a system viewer, and formatting said pages into one or more corresponding video images for display on a video monitor.

3. The system of claim 2, wherein said headend further includes a background screen generator for generating a digital background screen image to be broadcast by said distribution network on said at least one downstream channel, and said terminal processor application further includes a display manager for generating a video display image in which selected ones of said pages of programming information are overlaid on said background screen image.

4. The system of claim 2, wherein said terminal device further includes a memory for storing said pages of programming information.

5. The system of claim 4, wherein said terminal processor application further includes programming for pre-caching selected ones of said pages of programming information in said memory before a request for display of said selected pages of programming information is received from a viewer, said selected ones of said pages being referenced by or related to a currently displayed one of said pages.

6. The system of claim 4, wherein a background screen image, on which said pages of programming information are to be overlaid when formatted into a video image, is stored in said memory, and accessed by said terminal processor application.

7. The system of claim 4, wherein each of said pages of programming information is broadcast on a virtual digital channel contained within said downstream channel, and said terminal device further includes a channel mapping database in said memory that identifies a virtual digital channel to which each of said pages of programming information is assigned to facilitate display of said pages of programming information by said terminal processor.

8. The system of claim 4, wherein said terminal processor includes programming for highlighting selected text in one of said pages, accessing information related to said selected text in response to an input from a viewer, and displaying said related information in a selected area on one of said video images.

9. The system of claim 8, wherein said selected text comprises televison channel identification information and a program title, and said related information comprises a description of the programming content for said program title.

10. The system of claim 7, further including an input device for entering program guide requests into said terminal device.

11. The system of claim 10, wherein said input device includes a plurality of selection keys for selectively highlighting selected text displayed in said video image, and accessing additional ones of said pages of programming information.

12. The system of claim 10, wherein said input device includes a selection key for accessing a page of program guide information that corresponds to a next future time period for a group of channels whose program information for a selected time period is presently being displayed.

13. The system of claim 10, wherein said input device includes a selection key for accessing a page of program guide information that corresponds to a group of channels that is next in sequence to a group of channels whose program information for a selected time period is presently being displayed.

14. The system of claim 13, wherein said next group of channel information is selected by highlighting a highest numbered channel on a presently displayed page of program information, and pressing a selection key on said input device.

15. The system of claim 10, wherein said pages include category based groups of pages that include program information that is organized by a plurality of content related categories, and said category based pages are accessible by highlighting and selecting a category field on a displayed one of said pages.

16. The system of claim 10, wherein said input device further includes a selection key for accessing a channel on which a program that is currently highlighted on a displayed page of program information is broadcast.

17. The system of claim 1, further including a second digital multiplexer for receiving said multiplexed datastream from said first multiplexer, and multiplexing said datastream with a source of digital television signals to form a second multiplexed datastream that is comprised of said program guide information and said digital television signals, and is broadcast by said distribution network on said at least one downstream channel.

18. The system of claim 1, wherein said network headend further includes a database for storing program guide information to be accessed and formatted into said pages by said script generator.

19. The system of claim 1, further including a remote server for storing program guide information, and delivering said program guide information to said script generator in said headend to be formatted into said pages of programming information.

20. The system of claim 19, wherein said remote server is accessible by said script generator through the Internet.

21. The system of claim 1, wherein said script generator is programmed to generate updated pages of programming information on a periodic basis.

22. The system of claim 21, wherein said script generator generates updated pages of programming information every half hour.

23. A method for transmitting program guide information in a television distribution system comprising the steps of:
a) accessing programming guide information with a script generator in a network headend;
b) generating a plurality of pages of programming information from said program guide information, at least some of which include programming description information for a group of television channels during a selected time interval;
c) generating a multiplexed datastream from said pages in which said pages are interleaved with one another, and repeated in a carouseled manner; and
d) broadcasting said multiplexed datastream on at least one downstream channel interfaced to said network headend.

24. The method of claim 23, further comprising the steps of:
e) receiving said multiplexed datastream with at least one terminal device interfaced to said at least one downstream channel, said terminal device including a terminal processor; and
f) formatting said datastream with said terminal processor into a plurality of video images for display on a video monitor, at least some of said images including programming description information for multiple groups of television channels.

25. The method of claim 24, further comprising the steps of:
g) generating a digital background screen image with a background screen generator in said headend;
h) broadcasting said background screen image on said at least one downstream channel;
i) receiving said background screen image with said terminal device; and
j) generating a video display image with said terminal processor in which selected ones of said pages of programming information are overlaid on said background screen image.

26. The method of claim 25, further comprising the step of storing said background screen image in a memory in said terminal device.

27. The method of claim 24, further comprising the step of storing said pages of programming information in a memory in said terminal device as they are received.

28. The method of claim 27, wherein selected ones of said pages of programming information are pre-cached in said memory before a request for display of said selected pages of programming information is received from a viewer, said selected ones of said pages being referenced by or related to a currently displayed one of said pages.

29. The method of claim 27, wherein each of said pages of programming information is broadcast on a virtual digital channel contained within said downstream channel, and said terminal device further includes a channel mapping database in said memory that identifies a virtual digital channel to which each of said pages of programming information is assigned, said method further comprising the step of accessing said channel mapping database with said terminal processor to locate a selected one of said pages of programming information in said multiplexed datastream.

30. The method of claim 24, wherein said terminal processor further carries out the steps of highlighting selected text in one of said pages in response to an input received from an input device, accessing information related to said selected text in response to an input received from a viewer, and displaying said related information in a selected area on one of said video images.

31. The method of claim 30, wherein said selected text comprises televison channel identification information and a program title, and said related information comprises a description of the programming content for said program title.

32. The method of claim 24, further comprising the steps of entering one or more information requests into said terminal processor with an input device by actuating one or more keys on said input device, said information requests being selected from the group comprising a request for accessing a page of program guide information that corresponds to a next future time period for a group of channels whose program information for a selected time period is presently being displayed, a request for accessing a page of program guide information that corresponds to a group of channels that is next in sequence to a group of channels whose program information for a selected time period is presently being displayed, and a request for accessing a channel on which a program that is currently highlighted on a displayed page of program information is broadcast.

33. The method of claim 32, wherein said next group of channel information is selected by highlighting a highest numbered channel on a presently displayed page of program information, and pressing one of said keys on said input device.

34. The method of claim 23, wherein the step of accessing programming guide information with a script generator in a network headend further comprises accessing said information from a database in said headend.

35. The method of claim 23, wherein the step of accessing programming guide information with a script generator in a network headend further comprises accessing said information from a remote server.

36. The method of claim 35, wherein said remote server is accessed through the Internet.

37. The method of claim 23, further comprising the step of generating updated pages of programming information on a periodic basis.

38. The method of claim 37, further comprising the step of generating updated pages of programming information every half hour.

39. The method of claim 24, wherein said pages include category based groups of pages that include program information that is organized by a plurality of content related categories, and said category based pages are accessible by highlighting and selecting a category field on a displayed one of said pages.

40. A system for transmitting information comprising:
a) a network headend, said headend including a distribution network for transmitting a plurality of groups of text information;
b) at least one downstream channel interfaced to said distribution network for carrying said transmitted groups of text information;
c) a plurality of set top converter boxes for receiving said groups of text information, each said set top including:
1) a receiver for receiving said groups of text information; and
2) a terminal processor for managing display of said groups of text information, said terminal processor including a terminal processor application for selectively accessing and displaying one or more of said groups of text information in response to inputs from a system viewer;
d) a monitor interfaced to said set top for displaying said groups of text information; and
e) an input device for sending input commands to said terminal processor requesting display of one or more of said groups of text information.

41. The system of claim 40, wherein said headend further includes a first digital multiplexer for receiving said groups of text information and interleaving said groups into a plurality of carouseled, sequential data packets to form a multiplexed datastream that is broadcast by said distribution network on said at least one downstream channel .

42. The system of claim 41, further including a second digital multiplexer for receiving said multiplexed datastream from said first multiplexer, and multiplexing said datastream with a source of digital television signals to form a second multiplexed datastream that is comprised of said groups of text information and said digital television signals, and is broadcast by said distribution network on said at least one downstream channel.

43. The system of claim 40, wherein said headend further includes a background screen generator for generating a digital background screen image, and delivering said background screen image to said distribution network to be broadcast on said at least one downstream channel, and wherein, said terminal processor application further includes means for displaying said background screen image on said monitor, and overlaying selected ones of said groups of information on said background screen.

44. The system of claim 43 wherein said headend further includes an encoder for digitally encoding said background screen image before it is broadcast by said distribution network, and said set top further includes a decoder for decoding said background screen image after it is received by said receiver.

45. The system of claim 40, wherein said network headend further includes a server for accessing and formatting text information to be broadcast into said plurality of groups of text information.

46. The system of claim 45, wherein said headend further includes a database for storing said text information to be accessed and formatted by said server.

47. The system of claim 45, further including a remote server for storing said text information, and delivering said text information to said headend server to be formatted into said groups of text information.

48. The system of claim 47, wherein said remote server is accessible by said headend server through the Internet.

49. The system of claim 45, wherein said server formats said groups of information as HTML or HTML-like pages of information, each of said pages being formatted for display on said monitor.

50. The system of claim 40, further including at least one upstream channel, a distribution network in each said set top interfaced to said at least one upstream channel and a receiver in said network headend for communicating requests for said groups of text information from said set tops to said network headend.

51. The system of claim 40, wherein said set top further includes a memory for storing said groups of text information.

52. The system of claim 51, wherein said terminal processor application is further programmed for pre-caching selected ones of said groups of text information in said memory before a viewer enters a request for display of said selected groups of text information.

53. The system of claim 51, wherein a background screen image, on which said groups of text information are to be overlaid when displayed on said monitor, is stored in said memory, and accessed by said terminal processor application.

54. The system of claim 51, wherein each of said groups of information is transmitted on a virtual digital channel contained within said downstream channel, and said set top further includes a channel mapping database in said memory that identifies a virtual digital channel to which each of said groups of text information is assigned to facilitate display of said groups of text information by said terminal processor.

55. A method for transmitting information comprising the steps of:
a) providing a plurality of groups of text information in a network headend;
b) transmitting said plurality of groups of text information through at least one downstream channel to a receiver in at least one set top converter box for receiving said groups of text information, each said set top including:
c) receiving a request to display at least a selected one of said groups of text information from an input device interfaced to said set top;
d) accessing said selected one of said groups of information from said receiver; and
e) displaying said selected one of said groups of information on a monitor interfaced to said set top.

56. The method of claim 55, wherein said step of providing a plurality of groups of text information in said network headend headend further comprises multiplexing said groups of text information into a plurality of carouseled, sequential data packets to form a multiplexed datastream to be transmitted through said at least one downstream channel to said set top.

57. The method of claim 56, further including the step of multiplexing said multiplexed datastream with a source of digital television signals to form a second multiplexed datastream that is comprised of said groups of text information and said digital television signals, and is broadcast on said at least one downstream channel.

58. The method of claim 55, further including the steps of generating a digital background screen image in said network headend, and transmitting said background screen image to said set top for displaying said background screen image on said monitor, and overlaying selected ones of said groups of information on said background screen.

59. The method of claim 58, further including the steps of digitally encoding said background screen image before it is broadcast by said distribution network, and decoding said background screen image after it is received by said set top.

60. The method of claim 55, wherein the step of providing a plurality of groups of text information in a network headend further comprises accessing and formatting text information to be broadcast into said plurality of groups of text information with a server in said headend.

61. The method of claim 60, wherein the step of accessing further comprises accessing said text information from a database in said network headend.

62. The method of claim 60, wherein the step of accessing further comprises accessing said text information from a remote server.

63. The method of claim 62, wherein the step of accessing further comprises accessing said text information from a remote server through the Internet.

64. The system of claim 60, wherein said server formats said groups of information as HTML or HTML-like pages of information, each of said pages being formatted for display on said monitor.

65. The method of claim 55, further including the step of sending a request for said groups of text information from said set tops to said network headend via at least one upstream channel.

66. The method of claim 55, further including the step of pre-caching selected ones of said groups of text information in a memory in said set top before a viewer enters a request for display of said selected groups of text information.

67. The method of claim 55, wherein the step of accessing said selected one of said groups of information from said receiver further comprises accessing a channel mapping database in said set top that identifies a virtual digital channel to which each of said groups of text information is assigned, and determining a location in a broadcast datastream where said selected one of said groups of information is located.
